(19) United States
(12) Patent Application Publication
(10) Pub. No.: US 2026/0249557 A1
(43) Pub. Date: Aug. 27, 2026

(54) OPTIMIZED ADDITIVE MANUFACTURING OF OPTICS

(71) Applicant: Vadient Optics, LLC, Tualatin, OR (US)

(72) Inventors: George Melville Williams, JR., Vashon, WA (US); John Paul Harmon, Albany, OR (US)

(21) Appl. No.: 19/536,949

(22) Filed: Feb. 11, 2026

Related U.S. Application Data
(63) Continuation of application No. 19/112,430, filed on May 20, 2024.
(60) Provisional application No. 63/503,343, filed on May 19, 2023.

(51) Int. Cl. B29C 64/393; B29D 11/00; B29L 11/00; B33Y 10/00; B33Y 50/02; B33Y 80/00; G02B 3/00

(52) U.S. Cl. CPC B29C 64/393; B29D 11/00355; B29D 11/00432; B29D 11/00961; B33Y 10/00; B33Y 50/02; B33Y 80/00; B29K 2995/0006; B29L 2011/0016; G02B 3/0087

(57) ABSTRACT

Methods of manufacturing a target (prescription) optical device, such as a gradient complex dielectric optical device using additive manufacturing are disclosed. Test results from test coupons that comprise optical devices formed by additive manufacturing are used to monitor aspects of the additive manufacturing process for instances of the target optical device, including the material deposition process and material properties of component materials, such that the design and/or manufacture of the target optical device can be modified to improve performance to an intended result.

### CROSS-REFERENCE TO RELATED APPLICATIONS

The present application is a continuation of U.S. Non-Provisional patent application Ser. No. 19/112,430, filed Mar. 17, 2025 which is a U.S. National Phase of International Patent Application Serial No. PCT/US 2024/030182, filed May 20, 2024, which claims priority to U.S. Provisional Patent Application Ser. No. 63/503,343 filed May 19, 2023 and Entitled Optimized Additive Manufacturing of Optics, the entirety of each of which are hereby incorporated herein by reference for all purposes.

### TECHNICAL FIELD

This disclosure relates to the technical field of optical engineering, and more particularly to additive manufacturing of optical devices.

### SUMMARY

Methods of manufacturing one or more instances of a target (prescription) optical device are disclosed in which the target optical device has a gradient in a dielectric property in one or more spatial dimensions of the target optical device.

A disclosed method includes forming a test coupon comprising an optical device having a test gradient in the dielectric property in one or more spatial dimensions of the test coupon. The test coupon can be formed by material deposition of two or more component materials at relative proportions that varies in the one or more spatial dimensions of the test coupon. The two or more component materials differ in the dielectric property. The method further includes testing the test coupon by measuring an optical response to electromagnetic radiation on the test coupon. The method further includes forming the one or more instances of the target optical device by material deposition of the two or more materials by, for each instance of the one or more instances, varying relative proportions of the two or more component materials in the one or more spatial dimensions of the target optical device based on the optical response measured for the test coupon.

Another disclosed method includes forming a test coupon comprising an optical device having a test gradient in the dielectric property in one or more spatial dimensions of the test coupon. The test coupon can be formed by material deposition of two or more component materials at relative proportions that varies in the one or more spatial dimensions of the test coupon. The two or more component materials differ in the dielectric property. The method further includes testing the test coupon by measuring an optical response to electromagnetic radiation on the test coupon. The method further includes generating a print map for the target optical device based on the optical response measured for the test coupon. The method further includes forming the one or more instances of the target optical device by material deposition of the two or more materials by, for each instance of the one or more instances, varying relative proportions of the two or more component materials in the one or more spatial dimensions of the target optical device based on the print map.

### BRIEF DESCRIPTION OF THE DRAWINGS

FIG. 1 shows aspects of an example method of using test coupons in connection with manufacturing one or more instances of a target optical device, including optimization of the target optical device.

FIG. 2 shows aspects of an example method of using test coupons in connection with manufacturing one or more instances of a target optical device, including process control with respect to the target optical device.

FIG. 3 shows aspects of an example method of using test coupons in connection with manufacturing one or more instances of a target optical device in which the test coupons are used for in-line manufacturing flow.

FIG. 4 shows aspects of an additively manufactured optical device.

FIG. 5 shows aspects of an example test coupon or a portion thereof.

FIG. 6 shows aspects of an example test coupon or a portion thereof in which materials are deposited with different thicknesses.

FIG. 7A shows a top view in x-y dimensions of a contrast pattern of an example optical device where materials are deposited in various index values.

FIGS. 7B, 7C, and 7D show example z-dimensional thicknesses of the contrast pattern of the example optical device of FIG. 7A.

FIGS. 8A, 8B, and 8C show aspects of an example test coupon or a portion of a test coupon, wherein the square or rectangular (x, y) bar target, with unform composition in the z-dimension, are varied in spatial frequency, such that the transitions between a number of intermediate index levels is characterized over a number of spatial frequencies.

FIGS. 9A and 9B shows aspects of an example test coupon or a portion of a test coupon, whereby index patterns are formed in a transitioning index pattern from low to high, at different frequencies.

FIGS. 10A and 10B show aspects of an example test coupon or a portion of a test coupon, whereby the extent that the materials are deposited varies in the z-direction.

FIG. 11A shows aspects of an example test coupon or a portion of a test coupon, whereby single or few voxel (x, y) patterns are formed from different index value material printed on backgrounds of materials with different index values.

FIG. 11B shows aspects of an example top view of a small, circular (e.g., single voxel) pattern in the (x, y)-dimension.

FIG. 11C shows aspects of the corresponding side view, in the z-dimension, the cross section showing patterns reaching various levels into substrate.

FIG. 12 shows aspects of an example test coupon or a portion of a test coupon, whereby standard rotationally-symmetric lenses of various diameters are configured.

FIG. 13 shows aspects of a top view of various diameter GRIN lenses of differing diameter, with z-variations included.

FIG. 14 shows aspects of example point-spread functions, with frequency analysis.

FIG. 15 shows aspects of an example cross section, in the z-dimension, of two (or more) inks print-composed into gradients composed of sinusoidal modulations at different spatial frequencies.

FIG. 16 shows aspects of an example cross section, in the z-dimension, of two (or more) inks print-composed into gradients composed of sinusoidal modulations at different spatial frequencies.

FIG. 17 shows at (A) a cross section, in the z-dimension, of contrast patterns of an example test coupon or portion of a test coupon; at (B) an example indication of the extent to which the pattern can be varied; and at (C) an example indication of the extent to which the pattern and value of the index can be varied to match.

FIG. 18 shows a cross section, in the x, y-dimension, of a small, square index pattern of an example test coupon or portion of a test coupon, and different background contrast levels.

FIG. 19 shows aspects of an example system that can be used to perform the methods disclosed herein.

FIG. 20 shows aspects of an example computing system.

### DETAILED DESCRIPTION

A variety of manufacturing techniques exist for manufacturing optics. Traditional techniques, still widely in use today, involve grinding and polishing of optics with abrasive particles. Glass blanks are created via grinding, molding, or machining glass to roughly obtain the same shape, slightly greater in size, of the desired final optic. The blank or multiple blanks are mounted to a top or bottom polishing block in which the polishing blocks are shaped to match the desired optic shape. The polishing blocks are typically mechanized with the bottom block typically rotating and the top block moving across the bottom block by an actuated arm. Slurry comprising abrasive particles and water is continually added during polishing of the optic. As the optic goes through several stages of polishing, the grit size is reduced, until the resultant shape and surface finish is obtained. Unless a single optic is blocked, this technique is generally limited to planar, convex, and concave surfaces on circularly symmetric optics. Other techniques, which allow more complex surfaces and shapes include diamond-disc shaping, CNC machining with single-point diamond shaping, glass molding, polymer molding and magneto rheological figuring (MRF).

Additive manufacturing of optics has been a vibrant area of research. In 2015, the International Organization for Standardization (ISO) developed the ISO/ASTM 52900 standard describing the additive manufacturing process and defining its main terms and concepts. In 2021 this standard was revised, which describes seven additive manufacturing processes that are the basis for numerous 3D printing technologies used by different types of 3D printers.

Included in the types of manufacturing that may be used for printing optical devices, operational in the visible, infrared, terahertz, radio-frequency (RF), or millimeter-wavelength (MM) range include material extrusion techniques, such as Fused Deposition Modeling (FDM), Powder Bed Fusion, such as Selective Laser Sintering (SLS), Electron Beam Melting (EBM), and Multi Jet Fusion (MJF), Material Jetting, such as Material Jetting (MJ) and Drop on Demand (DOD), and Binder Jetting.

It has been demonstrated that additive manufacturing can be used to fabricate gradient index (GRIN) optics. By varying the properties of the material feedstock, as the optic is printed, or by print-composing heterogeneous materials by co-depositing, mixing, and inter-diffusing multiple feedstocks as the optic is composed, layer-by-layer, it is possible to create complex volumetric index gradients within an optical device. As an example, the index gradients may be composed by varying the permittivity and permeability of the materials, which relate to the refractive index. For at least some electromagnetic radiation domains (e.g., visible light), the refractive index spectra can be sufficient to describe the material properties.

In 3D GRIN materials, the refractive index may vary in up to three spatial dimensions, n(x, y, z). This allows, for example, implementation of spheric and aspheric 3D GRIN functions that may vary as a function of their position along the optical axis. These added degrees of freedom allow a single plane-parallel 3D GRIN optic to replace multiple lens surfaces, eliminating the need to fabricate, align, and bond multiple homogeneous index lens elements.

The flexibility of additive manufacturing allow complex freeform GRIN optics to be fabricated, in which there is no axis of symmetry throughout the array. A further benefit of multi-material additive manufacturing is that is it readily allows for optics to be fabricated that have integrated opaque baffles, edge-blackening, and aperture stops, as well as fiducial marks, mechanical mounting structures, and alignment holes, as examples.

To make GRIN optics using additive manufacturing, at minimum, a binary feedstock pair is used. A binary feedstock pair may consist of a “high index” material feedstock (nhigh), and a “low index” material feedstock (nlow). The difference in the index values of the two primary material feedstock at a reference wavelength is the maximum refractive index contrast, Δn. Using blended composition, intermediate refractive index values may then be created by locally depositing different concentrations of each primary drop.

The properties of nanocomposite feedstock may play a key role in additive manufactured fabricated optics. The refractive index spectra of nanocomposite feedstock may be tailored by embedding various concentrations of one or more types of organic or inorganic nanofillers in blends of photocuring monomers. Depending on the application, the nanofillers may be selected for the dielectric property, including one or more of refractive index, permittivity, permeability, or magneto-dielectric properties.

At least some printers allow multiple feedstock to be printed. The variety of feedstocks that can be concurrently printed depends on the number of available printheads controlled by the printer. Consumer printers typically allow four feedstocks to be concurrently printed, but it is common for industrial printers to accommodate more feedstocks. The ability of a printer to concurrently deposit and mix multiple optical feedstocks adds degrees of freedom for optimizing gradient index optics. For example, the binary (i.e., “high index” and “low index”) feedstock set described above may be complemented with a feedstock formulated with an intermediate index value (nᵢₙₜ) to allow for tri-level halftoning. Multi-level print composition allows for more control over the index gradient shapes and reduces the precision required for the deposition and polymerization processes to form complex gradient profiles composed of a wide range of spatial frequencies.

During fabrication, a stack of print maps, one for each printhead at each layer, are uploaded to the printer when fabricating the optic, layer-by-layer. Using industrial printers, the placement of the optical feedstock may be controlled to better than one micron precision, but after inter-diffusion of the concentrations of optical feedstocks and polymerization or solidification, it is possible to fabricate complex sub-wavelength smooth gradient profiles that precisely match the design intent.

To create refractive gradient index profile bitmaps using optical feedstock pairs, a halftoning process may be used. To accommodate three-dimensional refractive index volumes, i.e., n(x, y, z), the halftoning algorithms may quantize the refractive index profile designs in three dimensions. Some halftone algorithms use error diffusion, whereby the residuals from quantization are distributed to neighboring pixels that have not yet been processed. This method can also be extended to three-level or multi-level halftoning, so that several primary feedstock can be printed concurrently.

The bitmaps (as an example of a print map) determine the local densities for the high-index feedstock and low-index feedstock voxel locations, such that when they mix on the substrate, at sub-wavelength dimensions, the local composition takes on a complex refractive index spectrum that, at the sub-wavelength domain, is the weighted average of the locally deposited feedstock.

Binarization of the design for additive manufacturing may result in deviation from the original design intent. Moreover, especially in high volume manufacturing, material properties may vary, the process parameters may drift, and the additive manufacturing equipment may have specific biases or drift that causes its calibrated performance to change over time. The additive manufacturing methods disclosed herein offer the potential to address these and other issues.

The disclosure is generally directed to a three-dimensional test coupon structure for additive manufacture of optical device for use in multiple electromagnetic spectral domains. An illustrative embodiment of the test coupon structure includes a plurality of different spatial-frequency (x-y) dimensioned refractive index patterns that have different z-axis extensions. As used herein, a ‘test coupon’ comprises a physical, optical device that may be referred to alternatively as a calibration part, print-quality reference, print-evaluation sample, print-test, or test optic—in some cases interchangeably and in other cases depending on the implementation.

The disclosure is further generally directed to a method of fabricating standardized test coupons for additive manufacturing of optics. An illustrative embodiment of the method includes initiating fabrication of target (prescription) optical devices via additive manufacturing, and fabricating a test coupon via additive manufacturing with each batch of the target optical devices, removing the test coupon, and testing the optical properties of the test coupon to obtain a test result. This test result can inform aspects of the additive manufacturing process associated with the target optical devices, enabling manufacturing personnel to take corrective measures, in some cases.

The disclosure is also generally directed to assessing the quality of manufacture of freeform optical devices. In freeform optics, there are no degrees of symmetry within the optical device. In freeform GRIN optics, the freeform gradient index polynomial functions may vary in three-dimensions, which provides even more degrees of freedom. Also, the different dispersive characteristics of materials can cause the freeform optical functions to vary over or with respect to wavelength. Moreover, freeform optical device are often designed for use in complex optical assemblies with multiple other optical components. As a result, there are currently no suitable methods for a manufacturer to assess the optical quality of a freeform element. A test coupon, as disclosed herein, provides or otherwise enables a standardized method of assessing the manufacturing quality.

The disclosure is further generally directed to designing devices for manufacturability, wherein the test results of the test coupons, reveal relevant detail of the manufacturing parameters, such as halftoned bitmap algorithms, and process parameters, such as material diffusion, and printer-specific biases, so that changes may be incorporated into the manufacturing print files (e.g., the print maps) to optimize the optical device so that its “as fabricated” performance better matches the design intent.

In at least some examples, the test coupons may include contrast patterns, wherein the two, or more, primary feedstock are printed at various concentration mixes, for example to vary the index of refraction, or the magnitude of permittivity or permeability. For example, using binary feedstock, intermediate levels between the two materials, are constructed by print composition obtained by mixing the two materials. For refractive index levels, the test coupons can be tested by measuring the optical path length (OPL) or other optical response, which can vary linearly with the compositional mix of the materials, as an example. From these measurements, a contrast transfer function can be constructed that includes information on the material properties and the halftone algorithms, and at the borders between levels, reveal spatial frequency information.

In at least some examples, the test coupons include frequency varying patterns, wherein the two or more primary feedstock are printed at various concentration mixes, for example, to vary the index of refraction, or to vary the magnitude of permittivity or permeability between the limits of the materials, and at one or more of the index levels, and square or sinusoidal patterns are printed at different spatial frequencies, including those extending different heights, and locations, along the z-axis. Using measurements of the OPL, as an example, these test coupons may be used to quantify the diffusion of the materials, the print resolution, the layer-to-layer resolution, the halftoning process, and the properties of the materials.

In at least some examples, the test coupons include different composed index values of materials with patterns that vary in orientation along y-z, x-x, y-y, x-y, or x-y-z coordinates. These patterns may be used to assess the registration of printed layers and to assess the resolution of fabrication in the z-axis. Individual voxels and/or single voxel-thick lines formed within the three-dimensional test coupon can be used to assess manufacturing point spread functions and line spread functions, which can include the effects of diffusion at various times.

In at least some examples, the test coupons can include positive power and/or negative power optical devices, with different radial, axial, and radial & axial index distributions. Measuring the optical power (e.g., focal length of lenses), can be used to characterize the refractive index and dispersive properties of the feedstock. Analyzing the point spread function can be used to assess the Strehl ratio, which is a measure of the quality of optical image formation. The Strehl ratio can be defined as the ratio of the peak aberrated image intensity from a point source compared to the maximum attainable intensity using an ideal optical system limited only by diffraction over the system's aperture.

A Zernike analysis can be performed of the measured wavefront passing through the test coupons. The Zernike polynomials are a set of functions that are orthogonal over the unit circle. The individual Zernike basis functions (i.e., modes) correspond to classical optical aberrations, such as defocus, astigmatism, coma, and spherical aberration. Consequently, a Zernike expansion provides a convenient accounting scheme in which the total root mean squared (RMS) wavefront error is equal to the square root of the sum of the squares of the individual coefficients in the Zernike spectrum of a wavefront aberration map.

In at least some examples, test results obtained from testing of the test coupons can be used as feedback to modify the print maps used to fabricate a target optical device, for example by adding or subtracting Zernike polynomials from the print maps (e.g., bitmaps) in proportion to those measured to account for process or printer parameters.

In at least some examples, the feedback from the test coupons is used to modify process parameters as described in further detail herein.

In at least some examples, the feedback from the test coupons is used to modify the halftoning algorithm used to bi-level or multi-level discretize the design to allow for printing with a limited number of materials.

In view of the above, methods of manufacturing one or more instances of a target optical device are disclosed. The target optical device has a gradient in a dielectric property in one or more spatial dimensions of the target optical device, as an example.

A disclosed method includes forming a test coupon comprising an optical device having a test gradient in the dielectric property in one or more spatial dimensions of the test coupon. The test coupon can be formed by material deposition of two or more component materials at relative proportions that varies in the one or more spatial dimensions of the test coupon. The two or more component materials differ in the dielectric property. The method further includes testing the test coupon by measuring an optical response to electromagnetic radiation on the test coupon. The method further includes forming the one or more instances of the target optical device by material deposition of the two or more materials by, for each instance of the one or more instances, varying relative proportions of the two or more component materials in the one or more spatial dimensions of the target optical device based on the optical response measured for the test coupon.

A disclosed method includes forming a test coupon comprising an optical device having a test gradient in the dielectric property in one or more spatial dimensions of the test coupon. The test coupon can be formed by material deposition of two or more component materials at relative proportions that varies in the one or more spatial dimensions of the test coupon. The two or more component materials differ in the dielectric property. The method further includes testing the test coupon by measuring an optical response to electromagnetic radiation on the test coupon. The method further includes generating a print map for the target optical device based on the optical response measured for the test coupon. The method further includes forming the one or more instances of the target optical device by material deposition of the two or more materials by, for each instance of the one or more instances, varying relative proportions of the two or more component materials in the one or more spatial dimensions of the target optical device based on the print map.

The test coupon disclosed herein is a three-dimensional volume that can be formed from some or all of the same component materials used to form the target optical device. The test coupon can have a different dielectric configuration from the target optical device such that the dielectric property varies in one or more spatial dimensions of the test coupon in a manner that differs from the target optical device. For example, the test coupon can comprise an optical device that takes the form of a simpler/lower-dimension optic as compared to the target optical device, enabling the test coupon to be more easily tested (by interrogating with electromagnetic radiation and measuring the optical response) as compared to the target optical device. The test gradient in the dielectric property of the test coupon can comprise one or more localized regions within the three-dimensional volume having a different dielectric property than surrounding regions of the three-dimensional volume. A localized region of the one or more localized regions of the test coupon can include an individual voxel, a plurality of voxels that collectively form a linear shape, a planar shape, or a curved surface, or a plurality of voxels that form a three-dimensional volumetric shape in three spatial dimensions. Forming the test coupon and forming the one or more instances of the target optical device by material deposition can performed using the same additive manufacturing machine in which the two or more component materials are each supplied from a common source of that component material to form the test coupon and the one or more instances of the target optical device. The dielectric property can include one or more of refractive index, dielectric constant, permittivity, and/or permeability, as examples.

At least some of the methods disclosed herein comprise devising a three-dimensional (volumetric) test coupon comprising an optical device that may have a variety of zero-dimensional (e.g., single voxel), one-dimensional (e.g. lines), two-dimensional (e.g. lines, planes, circles, squares), and three-dimensional (spheres, cylinders, cubes, etc.) structures embedded, in various orientations, within the body of the three-dimensional test coupon. Measuring the test coupon with relevant probes via electromagnetic radiation in visible, infrared, radio-frequency (RF), and millimeter (MM) wavelength ranges, allows for characterization of the additive manufacturing process, which is used to modify aspects of the target optical device that is formed using the additive manufacturing process.

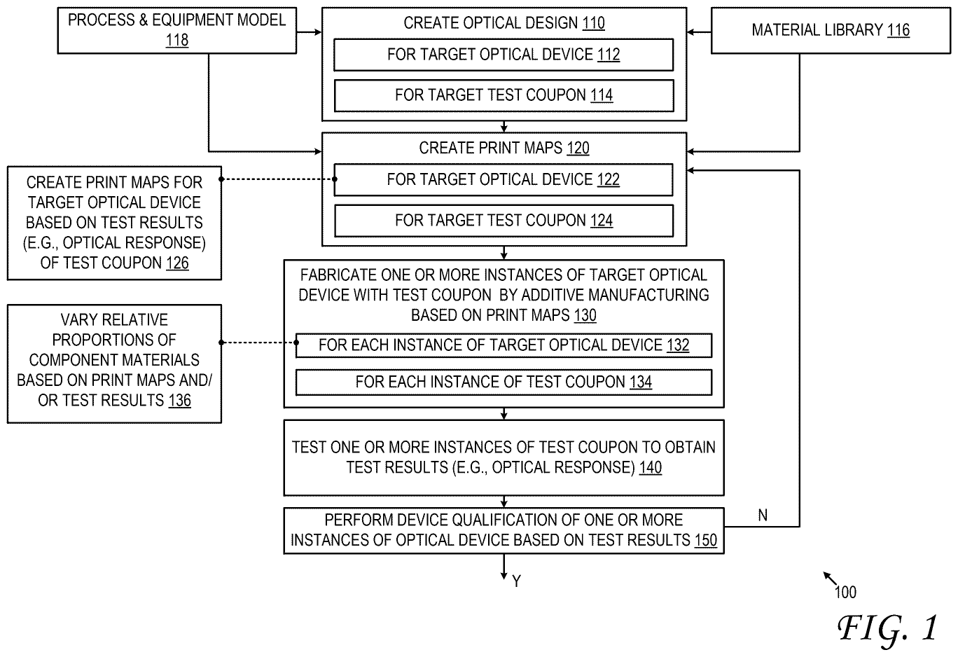

FIG. 1 is a flow diagram depicting an example method 100 of using test coupons for device optimization with respect to the manufacture of instances of a target optical device. As an example, method 100 can be used to optimize a target optical device formed by additive manufacturing.

At 110, an optical design for a target optical device is created at 112, and an optical design for a test coupon that comprises an optical device is created at 114. Creation of the optical design at 110 for the target optical device at 112 and for the test coupon at 114 can include input from or reference to a material library 116 that describes various properties (e.g., a dielectric property) of each component material of a plurality of component materials that can be used to form the target optical device and/or the test coupon. Furthermore, creation of the optical design at 110 for the target optical device at 112 and for the test coupon at 114 can include input from or reference to a process & equipment model 118 that describes features of a particular additive manufacturing process (having a particular additive manufacturing process type and associated attributes) and a particular additive processing system (having a particular equipment hardware configuration and associated attributes) that are to be used to additively manufacture the target optical device and the test coupon.

At 120, print maps are created for the optical design created at 110, which includes creation of a set of print maps for the target optical device at 122, and creation of a set of print maps for the test coupon at 124. The creation of print maps at 120 can utilize material library 116 and process & equipment model 118. For a particular optical design created at 110, one or more print maps are created to represent layers of the optical device to be formed by additive manufacturing. The print maps are discretized maps that determine the placement of each component material as the optical device is constructed, bottom-up, layer-by-layer. Each print map can include an array of values that correspond to an array of voxels that form a layer of the optical device in which the array of values can define a quantity or relative proportion of a component material for each voxel of the array.

As one example, for each layer of a three-dimensional optical device, a print map can be created for that layer for each component material of a plurality of component materials. In this example, a separate print map can be created for each component material at each layer. A set of two or more print maps for a given layer can be used to form that layer by additive manufacturing using two or more component materials in relative proportions that are defined by the set of print maps of that layer. As another example, a print map for each layer of an optical device can define a relative proportion of two or more component materials at each location (e.g., voxel) of that layer. In each of these examples, the print maps define a relative proportion of two or more component materials at each voxel within a three-dimensional array of voxels that form the optical device.

At 130, the method includes fabricating one or more instances of the target optical device at 132 with one or more instances of the test coupon at 134 by additive manufacturing based on the print maps created at 120. In the example of method 100, one or more instances of the test coupon are formed alongside one or more instances of the target optical device using the same additive manufacturing system and the same sources of component materials. As an example, one or more instances of the target optical device are formed at 132 by material deposition of two or more component materials in relative proportions as defined by the print maps created for the target optical device at 122; and one or more instances of the test coupons are formed at 134 by material deposition of two or more component materials in relative proportions defined by the print maps created for the test coupons at 124. However, in at least some examples, different additive manufacturing systems and/or different sources of the component materials can be used to form instances of the target optical device and the test coupon.

As part of operation 130, an instance of the test coupon can be fabricated at a predefined interval among fabrication of instances of the target optical device using the same additive manufacturing system, the same additive manufacturing process type, and the same component materials. As an example, the predefined interval can refer to a quantity of instances of the target optical device, a quantity of component materials used to fabricate the instances of the target optical device, or a duration of fabrication time. An instance of the test coupon can be fabricated prior to, following, or interspersed with fabrication of multiple instances of the target optical device.

At 140, the method includes testing one or more instances of the test coupon to obtain test results. As an example, the testing the test coupon at operation 140 includes measuring an optical response to electromagnetic radiation on the test coupon. In this example, the test results include the optical response or include data representing the optical response. In at least some examples, testing of the test coupon can be performed according to a predefined testing framework that enables standardization and comparison of the test results to a reference. For example, a predefined testing framework can define electromagnetic radiation of a particular wavelength or wavelength range that is to be directed at the test coupon at a predefined orientation relative to a reference frame of the test coupon, and the test result can be measured via one or more sensors arranged at another predefined orientation relative to the reference frame of the test coupon.

The test results from the test coupons are used to characterize the additive manufacturing processes and component materials. For example, at 150, the method includes performing device qualification of one or more instances of the target optical device fabricated at operation 132 based on the test results obtain from testing of one or more instances of the test coupon at operation 140. Device qualification at operation 150 may include additional optical tests of the target optical devices. If qualification of the instances of the target optical device is acceptable (Yes), the instances of the target optical device may be stocked, shipped, or otherwise used for their intended purpose or implementation. If qualification of the instances of the target optical device is not acceptable (No), the test results of the one or more instances of the test coupon may be used to create new print maps (e.g., updated or revised print maps) at operation 120.

Operations 120-150 can be repeated until qualification of instances of the target optical device is acceptable (Yes). For example, as indicated at 126, the method can include, as part of operation 122, creating one or more print maps (e.g., updated or revised print maps) for the target optical device based on the test results obtained at operation 140. Furthermore, as indicate at 136, the method can include, as part of operation 132, varying relative proportions of component materials used to form instances of the target optical device based on the print maps (e.g., the updated or revised print maps created at operation 126) and/or the test results obtained at operation 140.

The flow diagram of FIG. 1 is representative of the use of test coupons for process control, and there are other configurations of the modules, as well as levels of refinement of the manufacturing flow diagram, which are included in this disclosure.

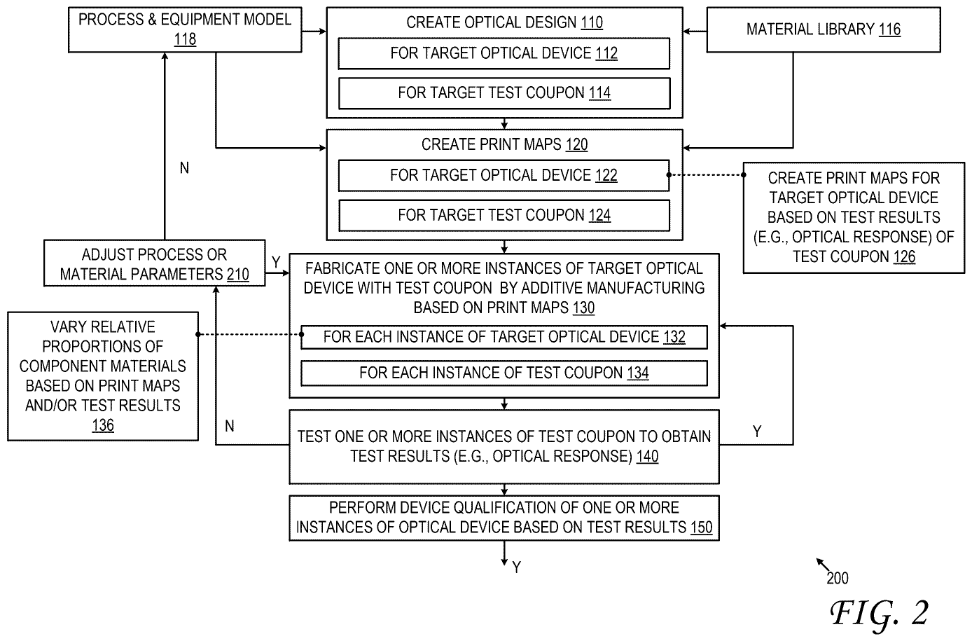

FIG. 2 shows aspects of an example method 200 of including test coupons for process control of a target optical device. Method 200 of FIG. 2 incorporates at least some of the operations previously described with reference to method 100 of FIG. 1. Additionally, in method 200, the test results from testing the test coupons are used for process control batch to batch without necessarily modifying or updating the print maps. For example, in method 200, fabrication of instances of the test optical device continues until measurements of the test results obtained from operation 140 falls outside some predetermined control limit. At that time, the test results of the test coupons may be used to adjust the process or material parameters as indicated at operation 210, and/or updating the process & equipment model 118. With a new process & equipment model, new manufacturing print maps may be used. Otherwise with the process parameters modified, manufacturing continues.

The flow diagram of FIG. 2 is representative of the use of the test coupons for process control, and there are other configurations of the modules, as well as levels of refinement of the manufacturing flow diagram, which are included in this disclosure.

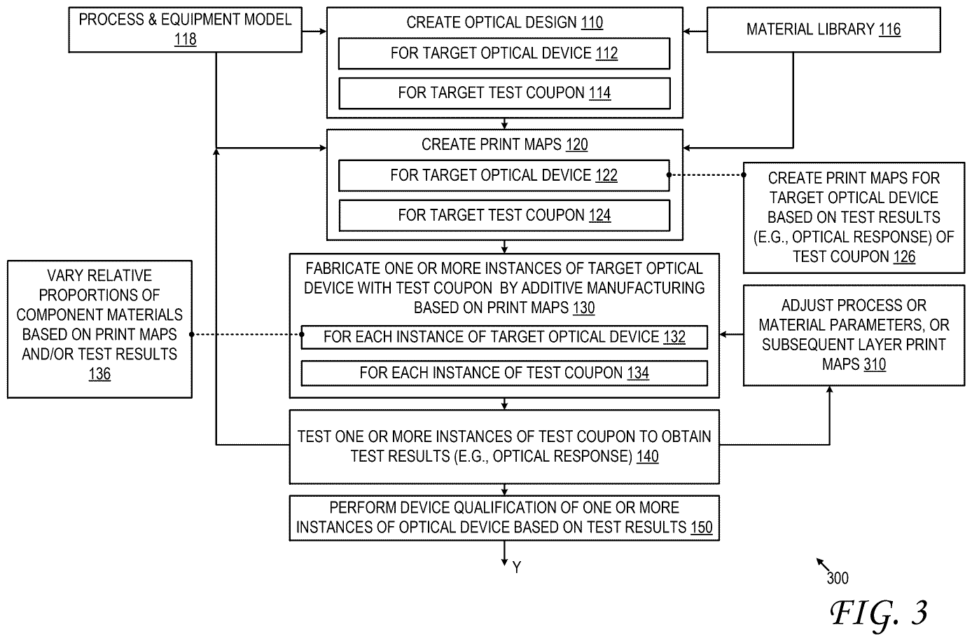

FIG. 3 shows aspects of an example method 300 of including test coupons in in-line manufacturing flow for a target optical device. Method 300 of FIG. 3 incorporates at least some of the operations previously described with reference to methods 100 and 200 of FIGS. 1 and 2. Additionally, in method 300, illustrates manufacturing flow for an additively manufactured target optical device whereby the test coupon is used for in-line testing and real-time process control, whereby the process is modified or the materials altered at 310, or the print maps changed during the fabrication of the target optical device. As an example, print maps and/or control of the additive manufacturing system used to form instances of a target optical device can be adjusted responsive to test results obtained from testing a test coupon during formation (e.g., between deposition of layers) of such instances of the target optical device. The flow diagram of FIG. 3 is representative of the use of the test coupons for process control, and there are other configurations of the modules, as well as levels of refinement of the manufacturing flow diagram, which are included in this disclosure.

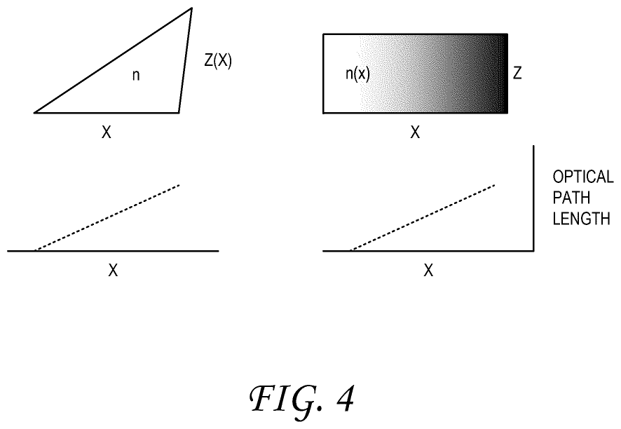

FIG. 4 shows, by way of example, how equivalent optical path lengths can be created between surface-figured optics made of homogeneous, fixed-index materials, and plano-plano gradient index devices with a fixed thickness. Unlike the surface-figured device, the GRIN can vary the index in three-dimensions, providing more degrees of freedom, which is reflected in the manufacturing characterization and control. More specifically, FIG. 4. is a schematic of an additive manufactured optical device.

FIG. 4 shows an optical device with varying surface figure and the optical path length (OPL) through the device as a function of the location on the x-axis. In this example, the wedge has a linear OPL that increases with the thickness of the device. FIG. 4 shows an equivalent optical device constructed of a plano-plano GRIN device, of fixed thickness, in which the refractive index is varied linearly along the x-axis dimension. Because the OPL is a product of the device thickness and the index of refraction, a comparable optical device can be manufactured. However, three-dimensional GRIN devices have the added degrees of freedom that the index can be varied throughout the optical volume. This creates additional requirements for process control.

The optical device can be fabricated for use in the ultra-violet, visible, infrared, terahertz, radio-frequency (RF), or millimeter (MM) wavelength ranges. In general, the optical media is composed of constituents sized at least λ/10.

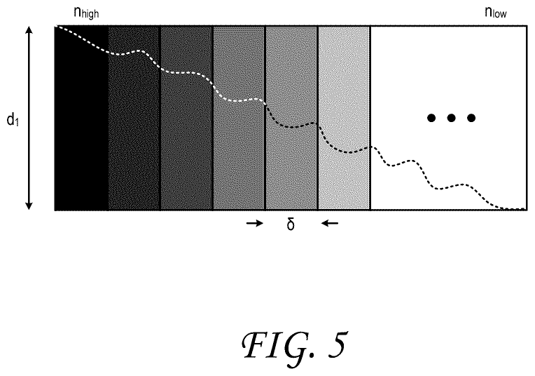

FIG. 5 shows aspects of an example test coupon or a portion of a test coupon. The test coupon is configured to create a variable magnitude of different optical path lengths by varying the index of refraction in stepped patterns, preferably with sharp transitions. The drawing provides a cross-section view, in the z dimension, of contrast patterns showing overlay of notional optical path length measurements. The contrast pattern may be linear or have a gamma function. The relative optical path length is shown in the dashed line for each thickness. Here a GRIN structure is shown, but an equivalent surface figure can be constructed with different thicknesses. In (z, y), the patterns may be linear or may be arranged in a step-wise radial GRIN lens. The steps (δ) may be varied in size to represent different spatial frequencies. Shown is the z-direction cross section of an (x-y) pattern of squared or rectangles. When a binary feedstock pair is used, the intermediate contrast levels are print-composed by mixing the two materials. Similarly multi-material deposition uses pre-deposition mixing or substrate-mixing to create intermediate index values. Printing the contrast patterns, at different thicknesses, including with calibration values that extend throughout the thickness of the device, can be used to vary the OPL. Shown overlayed on the structures are OPL notional measurements (not to scale). At the transition between the regions, the deviation of the transition from a straight drop may be used to assess the inter-diffusion of materials, and may be used to assess the alignment of the print layers in the z-direction. The diffusion effects are time and temperature dependent and these variables may be included in analysis of the test coupons.

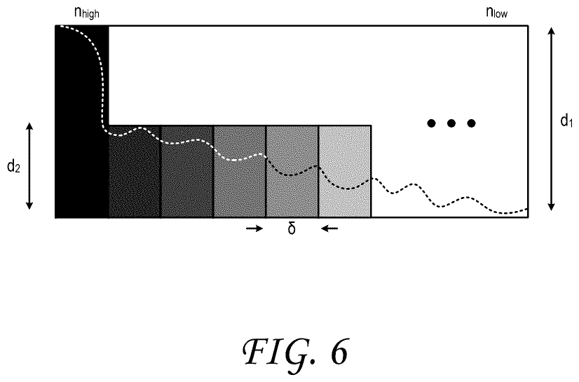

FIG. 6 shows, by way of example, that the materials can be printed with different thicknesses. More specifically, FIG. 6 shows contrast patterns printed at different thicknesses. Other than the control printed at the full device layer thickness, the fabricated optical thickness of the contrast pattern extend only a portion of the z-dimension. However, different combinations of thickness and index can be devised to create regions with a constant OPL.

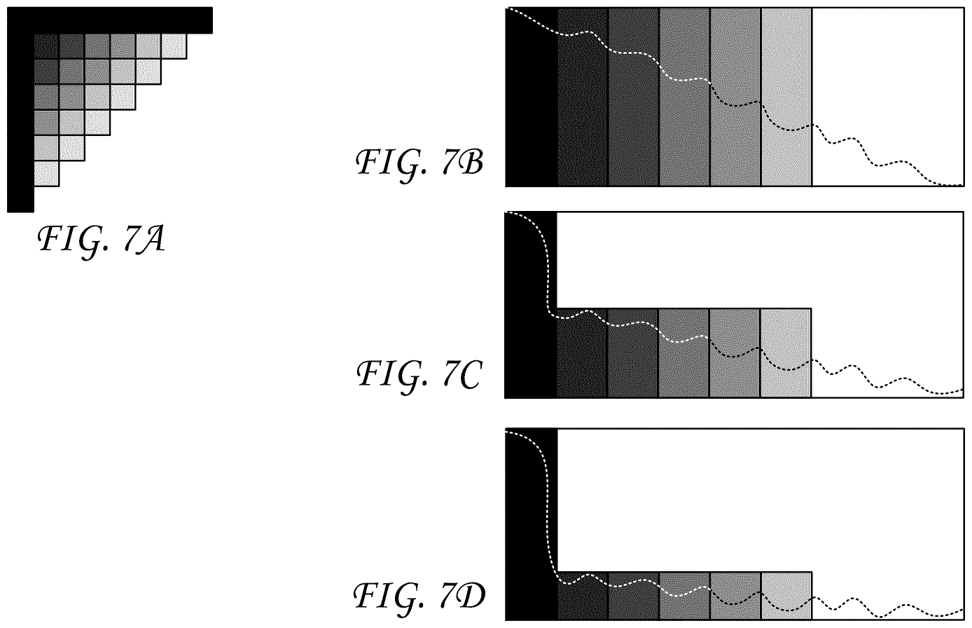

This is shown also in the examples of FIGS. 7A-7D. FIG. 7A shows a top view in x-y dimensions of a contrast pattern of an example optical device where materials are deposited in various index values. FIGS. 7B, 7C, and 7D show example z-dimensional thicknesses of the contrast pattern of the example optical device of FIG. 7A. As an example, the goal is to calibrate the printed material composition with the thickness (e.g., FIGS. 7B, 7C, and 7D) that shows the extent to which the optical material is printed relative to the total thickness of the device. The black border is used to calibrate and normalize the measurements. Here the thickness and refractive index are varied causing for regions of constant OPL. For layers thinner than the device thickness, the regions may be fabricated at any point along the Z-axis.

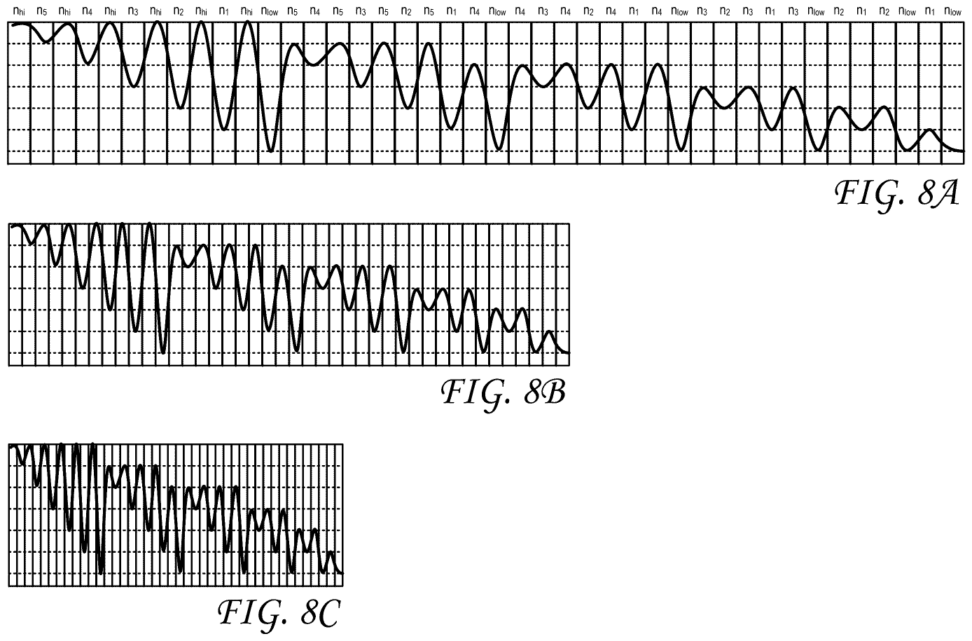

FIGS. 8A, 8B, and 8C show aspects of an example test coupon or a portion of a test coupon, wherein the square or rectangular (x, y) bar target, with unform composition in the z-dimension, are varied in spatial frequency, such that the transitions between a number of intermediate index levels is characterized over a number of spatial frequencies. FIGS. 8A, 8B, and 8C each depict a cross section, in the z-dimension, of multiple materials (e.g., inks) or multiple print composed index levels, showing contrast between all different levels, at different spatial frequencies. These patterns may be oriented in (x, y) at different angles relative to the printer direction (e.g. orthogonal and diagonal). Different device thicknesses, showing no gradient variation in the z dimension may be used to test three-dimensional alignment. The solid line in FIGS. 8A, 8B, and 8C shows effective optical path length. In at least some examples, the spatial frequency ranges cover near-DC conditions, as well as those corresponding to the diffusion lengths at relevant time lengths, as well as those of the characteristic printer resolution, inter-layer registration, and optical scattering. Various thickness devices can be fabricated to assess layer to layer registration and diffusion. The information may be used to inform the process for creating print maps for a target optical device.

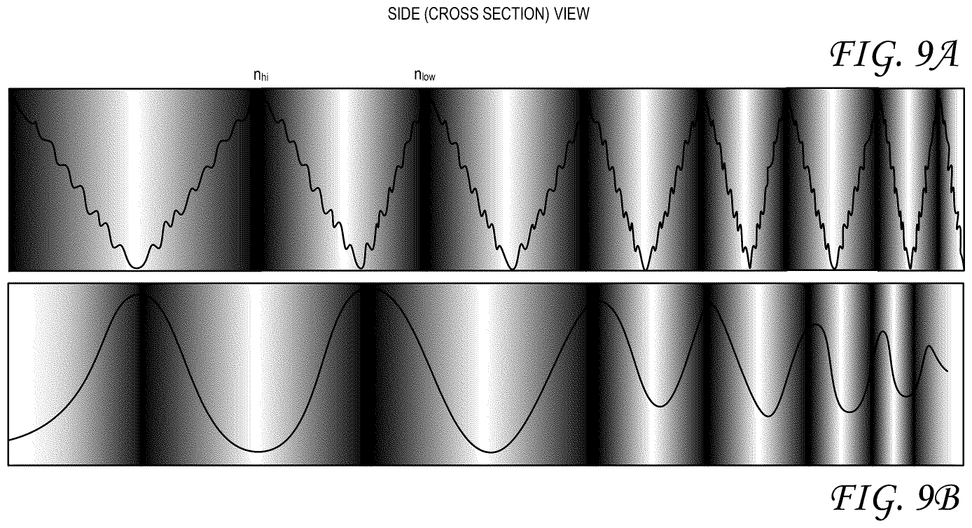

FIGS. 9A and 9B show aspects of an example test coupon or a portion of a test coupon, whereby index patterns are formed in a transitioning index pattern from low to high, at different frequencies. FIG. 9A is an example cross section of a test coupon, were two or more inks were print-composed into gradients composed of sinusoidal or linear modulations at different spatial frequencies. The spatial pattern could also be configured linearly in different (x, y) orientations or radially (θ). FIG. 9B shows aspects of three different pattern thicknesses, illustrating a sinusoidal variation. The solid line shows notional optical path length measurements superposed on the pattern, but not plotted to scale. At the top (FIG. 9A) are linear transitions, from high to low, but the transitions could include sinusoidal, parabolic, or other transition patterns. The transitioning patterns determine the δn/δ(z,y) characteristics of the process, for a given set of processes and material parameters. In FIG. 9B, the patterns may include variation in the z-dimension.

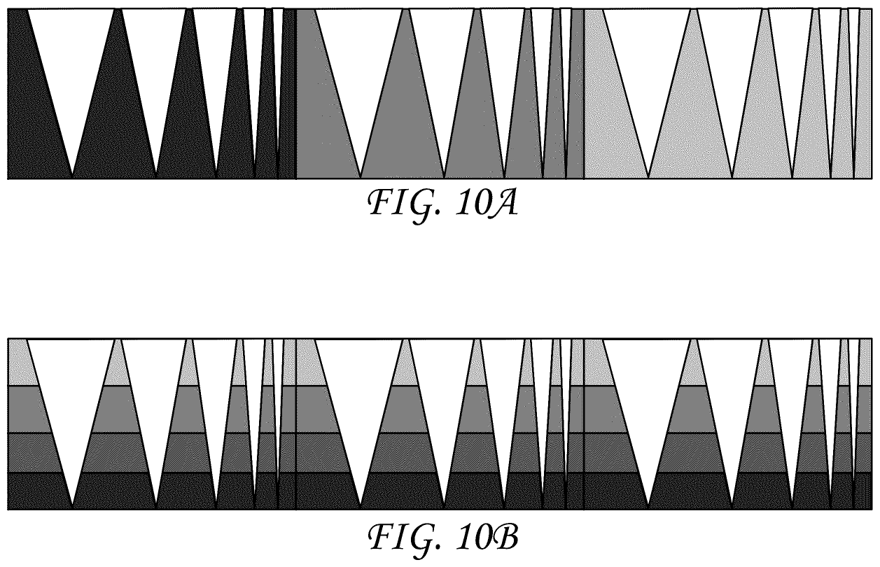

FIGS. 10A and 10B show aspects of an example test coupon or a portion of a test coupon, whereby the extent that the materials are deposited varies in the z-direction. Shown in FIG. 10A is a side-view cross section of test-coupon inks printed at various extents into the z-dimension forming a pattern. The transitions in the z-direction vary in frequency. Shown in FIG. 10B is a side view where the transitions are performed on axially varying materials. In FIGS. 10A and 10B, the optical path is omitted for clarity, and the extent of the z-direction is patterned along the x-axis or y-axis dimension in triangular function, although any other suitable function can be used. In FIG. 10B, the material composition is changed axially, in addition to the extent of material in the z-dimension.

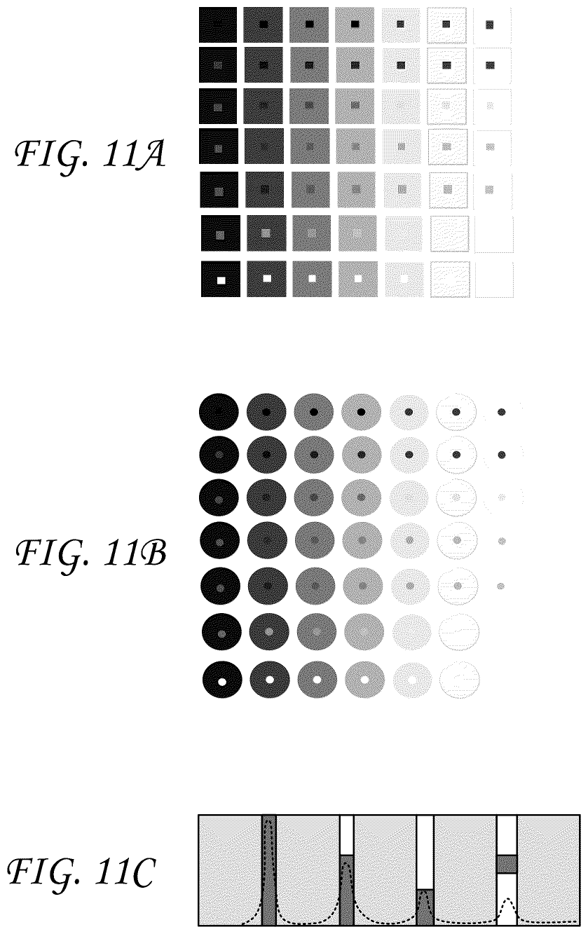

FIG. 11A shows aspects of an example test coupon or a portion of a test coupon, whereby single or few voxel (x,y) patterns are formed from different index value material printed on backgrounds of materials with different index values. The drawing provides a top view of a small, square index pattern in the (x,y)-dimension, with different background-contrast levels. The square patterns may also range in size from the smallest voxel size to larger. Contrasts between intermediate levels are shown. Both positive and negative contrast targets are represented. The measured OPL, form devices of various thickness, represents a point spread function that can be used to characterize the process.

FIG. 11B shows aspects of an example top view of a small, circular (e.g., single voxel) pattern in the (x,y)-dimension. In some examples, the circular pattern may be formed from a single voxel deposition. In other examples, the circuit pattern may be formed from a plurality of voxels.

FIG. 11C shows aspects of the corresponding side view, in the z-dimension, the cross section showing patterns reaching various levels into substrate. This drawing shows that the patterns can extend different extents in the z-direction, and can include single z-dimension voxel representations.

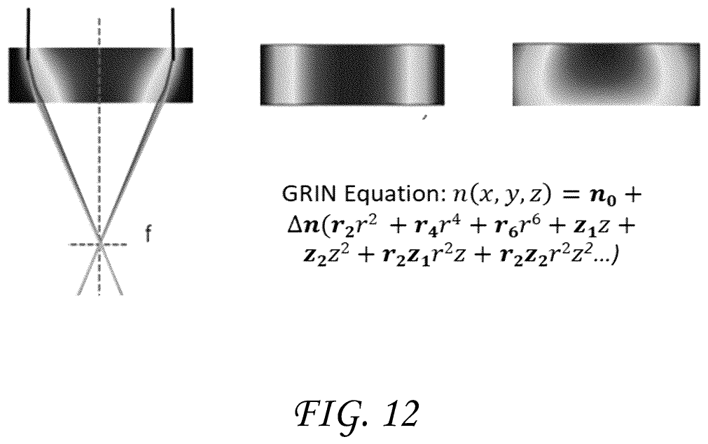

FIG. 12 shows aspects of an example test coupon or a portion of a test coupon, whereby standard rotationally-symmetric lenses of various diameters are configured. The drawing provides a side view. Lens patterns with variable radius and varying radial and axial gradients can be used. The material properties can be assessed by examining the focal length at multiple wavelengths. The lenses may have index patterns that vary differently as a function of radius, as indicated in the GRIN function shown. The lenses may have three-dimensional index patterns that vary differently as a function of radius and axial dimension. In addition to testing the print process, measurement of the focal lengths at various wavelengths can be used to assess the dispersive properties of the materials.

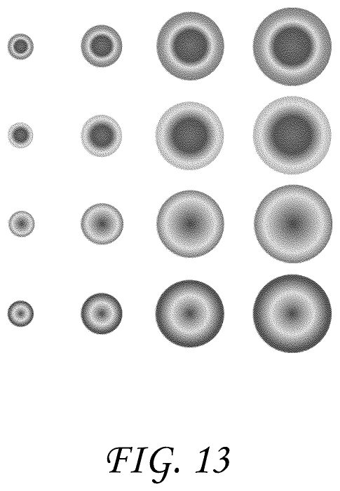

FIG. 13 shows aspects of a top view of various diameter GRIN lenses of differing diameter, with z-variations included.

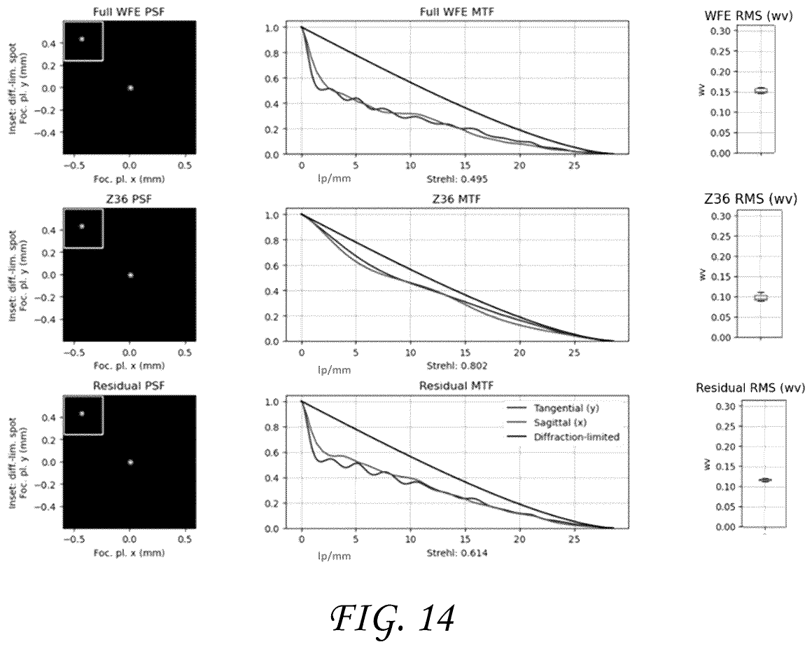

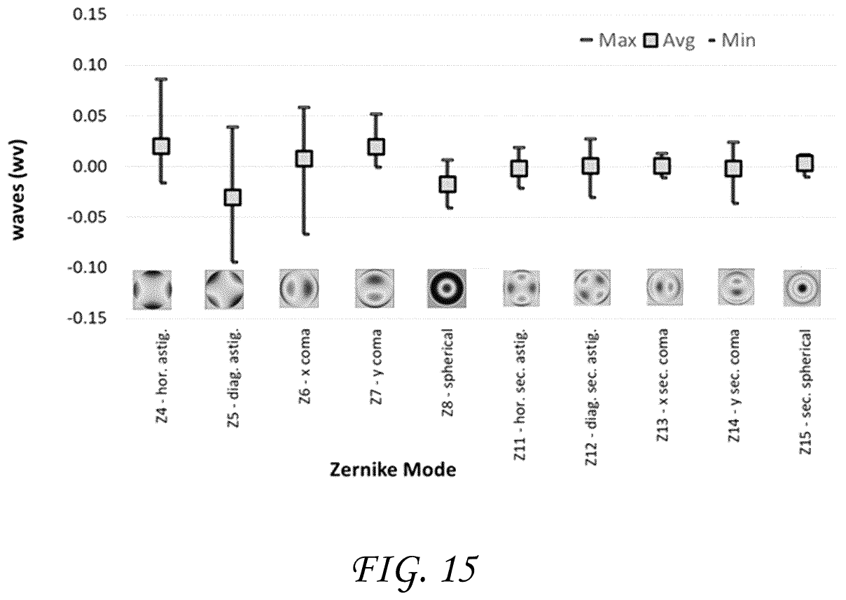

FIG. 14 shows aspects of example point-spread functions (left), with frequency analysis (middle), and wavefront error (right) measured over a 3-mm aperture using digital holographic microscopy. The top row shows measured data. The middle row shows data including contribution from the first 36 Zernike polynomials (only). The bottom row shows residual (higher order Zernike polynomial) contributions to data. The Strehl ratio is listed for each case. FIG. 15 shows aspects of a corresponding Zernike decomposition of the measurement, showing contributions from first 15 Zernike polynomials. More specifically, FIG. 14 shows example point spread functions and modulation transfer function (MTF) analysis of the point spread functions of the test coupons, including the Strehl ratio, obtained from the optical path difference (OPD) measured using a Digital Holographic Microscope. Shown here is the measured MTF of the test coupon lenses showing contributions from all Zernike polynomials and from portions of the Zernike polynomial sets. Shown also are wavefront-error contributions from different Zernike polynomials.

Within FIG. 14, the tangential and sagittal modulation transfer function (MTF) curves obtained from the DHM measurements of the point spread function (PSF) are shown, measured at the focal plane, compared to diffraction limited performance. Point spread functions (left), frequency analysis (middle), and wavefront error (right) are measured over a 3-mm aperture using DHM. The top row shows measured data. The middle row shows data including contribution from the first 36 Zernike polynomials (only). The bottom row shows residual (higher order Zernike polynomial) contributions to data. The Strehl ratio is listed for each case. The 4-mm lenses have an average focal length of about 216 mm (f/54), which results in a diffraction limited spot size of 77.1 microns and a limiting resolution of 31.55 lp/mm.

A 0.15 wave RMS error was measured. A Strehl ratio(S) of 0.5 was measured over a 3-mm clear aperture of the lenslets. The Strehl ratio is the ratio of maximum focal spot irradiance of the actual optic from a point source to the ideal maximum irradiance from a theoretical diffraction-limited optic. To analyze the WFE contributions, an aberration transfer function (ATF) curve was created from the high order Zernike polynomials.

In terms of frequency analysis, the frequency response of an optical system is reduced by phase distortion within the passband. The plot of FIG. 14 (middle) shows the MTF performance with contributions from only the first thirty-six Zernike polynomials. The data shows about 0.10 RMS total wavefront error in this frequency range. A Strehl ratio of 0.802 was calculated when only the LSF figure errors were included. A Strehl ratio S≥0.8 is generally considered to correspond to diffraction-limited performance.

FIG. 14 (bottom) shows the MTF curve that includes contributions from only the higher order (i.e. larger than Z36) Zernike polynomials. A Strehl ratio of 0.614 was calculated when only contributions from mid-spatial-frequency (MSF) and high-spatial-frequency (HSF) errors were included in the measurement. This shows that the higher frequency errors significantly contributed to the overall optical power of the WFE. The data shows about 0.12 wave RMS error in this frequency band.

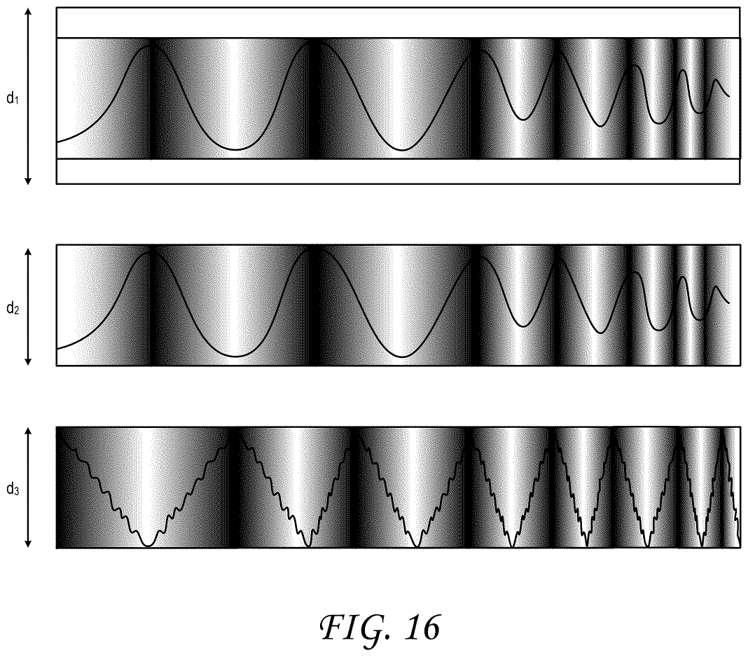

FIG. 16 shows aspects of an example cross section, in the z-dimension, of two (or more) inks print-composed into gradients composed of sinusoidal modulations at different spatial frequencies. The spatial patterns may be linear, oriented in (x, y) or may be formed in radial patterns about a center. Three different device thicknesses showing no gradient variation in z, are shown. Variations in z can be added as well, for example they may be modulated with a radial distribution. The solid line shows the effective optical path length.

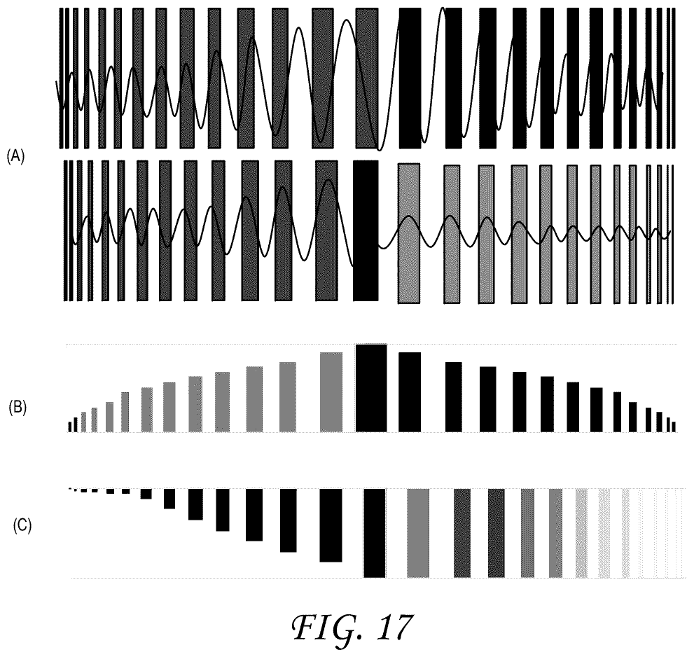

FIG. 17 shows aspects of an example cross section (A), in the z-dimension, of contrast patterns, either primary optical inks, or print-composed, showing optical path length. Different device thicknesses can be tested, and different contrasts can be tested. The black pattern (maximum path length) can be used for a reference. At (B) the drawing shows an example extent to which the pattern can be varied (e.g., ½, ¼, or some octave), to show z-directional effects in printing. The extent of the z-direction can be from the bottom or the top. At (C) the drawing shows that the extent of the pattern and the value of the index of the material can be varied to match. For example ½ thickness should be the same as full thickness of a device with ½ intermediate refractive index. Similarly, it is possible to create a linear OPL. All patterns can be linear, cross-patterned, or radial/circular to show printer biases.

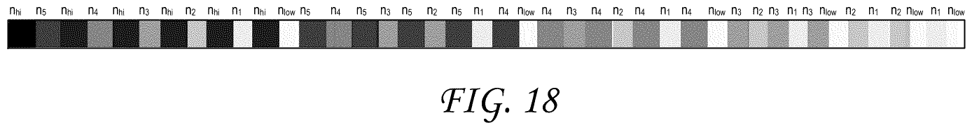

FIG. 18 shows aspects of an example cross section, in the x, y-dimension, of a small, square index pattern and different background contrast levels. The square patterns may also range in size from the smallest voxel size to larger. Contrasts between intermediate levels are shown in the labels. The corresponding side view in the z-dimension is provided in FIG. 11C hereinabove, such cross section showing patterns reaching various levels into substrate. The heights and index values may be tailored such that the index is anticipated to be uniform across the portion of the test array.

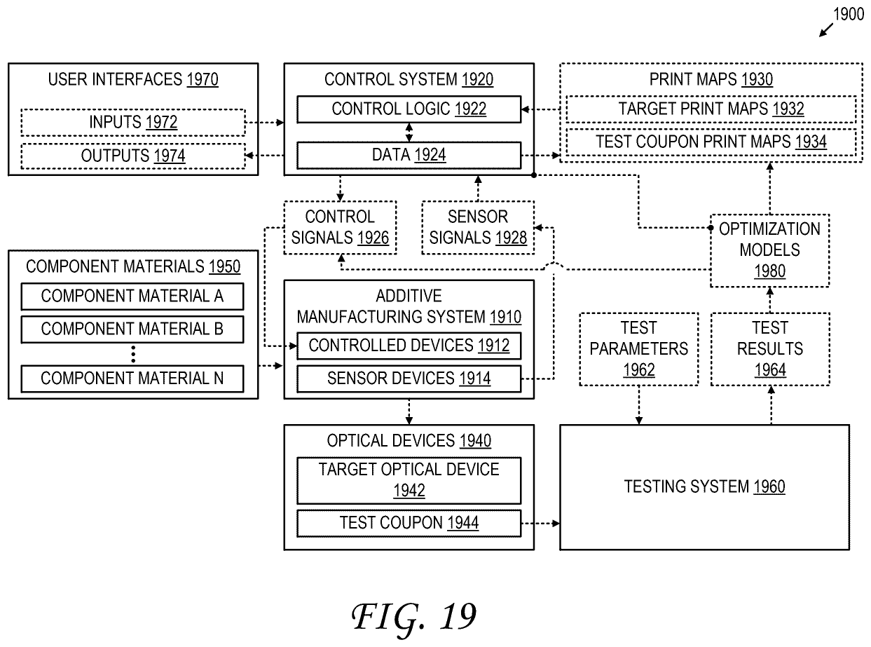

FIG. 19 shows aspects of an example system 1900 that can be used to perform the methods disclosed herein. System 1900 includes an additive manufacturing system 1910 that includes a set of controlled device 1912 and a set of sensor devices 1914. Additive manufacturing system 1910, depicted schematically in FIG. 19, can be used to fabricate any of the optical devices described herein by additive manufacturing in which two or more component materials are deposited in varying relative proportions in one, two, or three dimensions of the optical device.

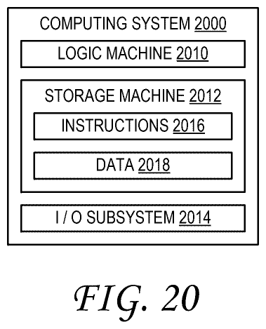

System 1900 includes a control system 1920 that can be used to control operation of additive manufacturing system 1910. In at least some examples, control system 1920 can take the form of a computing system of one or more computing devices, as described in further detail herein with reference to FIG. 20. Control system 1920 includes control logic 1922 and data 1924. As depicted schematically in FIG. 19, control system 1922 implementing control logic 1922 can send control signals 1926 to controlled devices 1912 of additive manufacturing system 1910, and can receive sensor signals 1928 from sensor devices 1914 of additive manufacturing system 1910. Accordingly, control system 1920 can perform additive manufacturing of the various optical devices described herein through operation of additive manufacturing system 1910.

Data 1924 includes print maps 1930, which can include target print maps 1932 for the additive manufacture of a target optical device, and test coupon print maps 1934 for the additive manufacture of a test coupon that comprises an optical device. Print maps 1930 can be used by control system 1920 implementing control logic 1922 to control additive manufacturing system 1910 to form optical devices 1940, depicted schematically in FIG. 19. As an example, control system 1920 can implement control logic 1922 using target print maps 1932 to control additive manufacturing system 1910 to form one or more instances of a target optical device 1942. As another example, control system 1920 can implement control logic 1920 using test coupon print maps 1934 to form a test coupon 1944 that comprises an optical device.

Instances of target optical device 1942 that are formed by additive manufacturing using additive manufacturing system 1910 can have a gradient in a dielectric property in one or more spatial dimensions of the target optical device. As an example, one or more instances of target optical device 1942 can be formed by material deposition of two or more component materials 1950 via controlled devices 1912 of additive manufacturing system 1910.

In FIG. 19, examples of component materials 1950 are depicted schematically as component material A, component material B, and component material N, where “N” represents an integer quantity of zero or more additional component materials. Accordingly, component materials 1950 can include any suitable quantity of component materials (e.g., 1, 2, 3, 4, 5, or more) as feedstock for additive manufacturing system 1910 that can be selectively deposited at relative proportions at each voxel of an optical device responsive to control signals 1926 provided by control system 1920. The two or more component materials 1950 differ in a dielectric property (examples of which are described herein), which can be mixed in any suitable combination to provide a resultant dielectric property at each voxel of an optical device.

Control system 1920 can vary relative proportions of the two or more component materials 1950 deposited to form an optical device according to print maps 1930. One or more print maps can define a relative proportion of each component material for each voxel of an optical device. For example, for each instance of target optical device 1942 formed by material deposition using additive manufacturing system 1910, control system 1920 can vary relative proportions of the two or more component materials 1950 in one or more spatial dimensions of the target optical device as defined by target print maps 1932. As another example, control system 1920 can control additive manufacturing system 1910 to form a test coupon 1944 having a test gradient in a dielectric property in one or more spatial dimensions of the test coupon. In this example, test coupon 1944 can be formed by material deposition of the two or more component materials 1950 at relative proportions that varies in the one or more spatial dimensions of the test coupon as defined by test coupon print maps 1934.

System 1900 further includes a testing system 1960, depicted schematically in FIG. 19. Test coupon 1944 can be tested according to test parameters 1962 using testing system 1960 to obtain test results 1964. As an example, test coupon 1944 can be tested by measuring an optical response to electromagnetic radiation on the test coupon. In at least some examples, electromagnetic radiation (e.g., in the form of a laser) of a particular wavelength or wavelength range can be directed at the test coupon to generate an optical response, which is measured as test results 1964. Test results 1964 can include data representing the optical response to electromagnetic radiation measured for test coupon 1944 using testing system 1960. As examples, the test results include a measure of optical path length (OPL) or optical path difference (OPD). Test results 1964 can be stored as part of data 1924 within control system 1920. As previously described with references to the methods disclosed herein, one or more instances of target optical device 1942 can be formed by material deposition by, for each instance of the target optical device, varying relative proportions of the two or more component materials 1950 in one or more spatial dimensions of the target optical device based on the optical response measured for the test coupon.

System 1900 further includes one or more user interfaces 1970 by which inputs 1972 (e.g., user inputs) can be provided to control system 1920 and outputs 1974 can be presented by control system 1920. Outputs 1974 can include various forms of data that represent sensor signals 1928, control signals 1926, print maps 1930, test results 1964, and test parameters 1962, as examples. Inputs 1972 can be provided to control system 1920 as data that represent control signals 1926, print maps 1930, and test parameters 1962, as examples. User interfaces 1970 can form part of control system 1920, in at least some examples. Alternatively or additionally, user interfaces 1970 can be provided via a separate device, such as a client computing device, peripheral device, etc.

Control system 1920 can implement one or more optimization models 1980 in connection with test parameters 1962 and test results 1964 to modify or update print maps 1930 (e.g., target print maps 1932) and/or process control of additive manufacturing system 1910 (e.g., via control signals 1926). As an example, optimization models 1980 can be used to create modified or updated print maps for a target optical device based on measured values of test results 1964. Optimization models 1980 can include a modulation transfer function, and/or can incorporate Zernike decomposition, as examples.

In at least some examples, the methods and operations described herein may be tied to a computing system of one or more computing devices. In particular, such methods and operations can be implemented as a computer-application program or service, an application-programming interface (API), a library, and/or other computer-program product.

FIG. 20 shows aspects of an example computing system 2000 that can perform one or more of the methods and operations described herein. In at least some examples, control system 1920 of FIG. 19 can take the form of computing system 2000. In FIG. 20, computing system 2000 is depicted schematically in simplified form. Computing system 2000 can take the form of one or more personal computers, server computers, mobile computers, network computing devices, and/or other computing devices. Computing system 2000 includes a logic machine 2010, a storage machine 2012, and an input/output (I/O) subsystem 2014.

Logic machine 2010 includes one or more physical devices configured to execute instructions. For example, the logic machine may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

The logic machine may include one or more processors configured to execute software instructions. Additionally or alternatively, the logic machine may include one or more hardware or firmware logic machines configured to execute hardware or firmware instructions. Processors of the logic machine may be single-core or multi-core, and the instructions executed thereon may be configured for sequential, parallel, and/or distributed processing. Individual components of the logic machine optionally may be distributed among two or more separate devices, which may be remotely located and/or configured for coordinated processing. Aspects of the logic machine may be virtualized and executed by remotely accessible, networked computing devices configured in a cloud-computing configuration.

Storage machine 2012 includes one or more physical devices configured to hold instructions 2016 and other data 2018 executable by the logic machine to perform or otherwise implement the methods and operations described herein. When such methods and operations are performed or otherwise implemented, the state of storage machine 2012 may be transformed—e.g., to hold different data. Control logic 1922 of FIG. 19 is an example of logic machine 2010 executing instructions 2016 of FIG. 20. Data 1924 of FIG. 19 is an example of data 2018 of FIG. 20.

Storage machine 2012 may include removable and/or built-in devices. Storage machine 2012 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage machine 2012 may include volatile, nonvolatile, dynamic, static, read/write, read-only, random-access, sequential-access, location-addressable, file-addressable, and/or content-addressable devices. It will be appreciated that storage machine 2012 includes one or more physical devices. However, aspects of the instructions described herein alternatively may be propagated by a communication medium (e.g., an electromagnetic signal, an optical signal, etc.) that is not held by a physical device for a finite duration.

Aspects of logic machine 2010 and storage machine 2012 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

The terms “module,” “program,” and “engine” may be used to describe an aspect of computing system 2000 implemented to perform a particular function. In some cases, a module, program, or engine may be instantiated via logic machine 2010 executing instructions 2016 held by storage machine 2012. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

As an example, instructions 2016 can include an additive manufacturing program executable by logic machine 2010 to control operation of additive manufacturing systems (e.g., 1910 of FIG. 19) and associated hardware to form instances of a target optical device and a test coupon using print maps, as described herein. Instructions 2016 can further include a test program executable by logic machine 2010 that receives test results (e.g., 1964 of FIG. 19), processes the test results to obtain a solution (e.g., by applying one or more optimization models 1980 of FIG. 19), and outputs the solution, which can include one or more of: updated print maps or modifications to print maps of a target optical device, control signals or modifications to control signals used to operation additive manufacturing systems (e.g., 1910 of FIG. 19), and/or alerts that identify instances of a target optical device that do not satisfy device qualification parameters based on the test results of the test coupon.

Input/output subsystem 2014 enables computing system 2000 to communicate with one or more other devices over wired and/or wireless communications links. As an example, input/output subsystem 2014 can be used by computing system 2000 to send control signals 1926 of FIG. 19 to additive manufacturing system 1910, and to receive sensor signals 1928 from additive manufacturing system 1910. As another example, input/output subsystem 2014 can be used by computing system 2000 to send outputs 1974 to user interfaces 1970 of FIG. 19, or to receive inputs 1972 from user interfaces 1970. Furthermore, in at least some examples, input/output subsystem 2014 can include or interface with one or more devices that comprise user interfaces 1970 of FIG. 19. As an example, input/output subsystem can include or interface with user input devices such as a keyboard, computer mouse, graphical display, etc. As an example, outputs 1974 of FIG. 19 can include data representing test results 1964, and inputs 1972 of FIG. 19 can include user-defined modifications or changes to print maps 1930, 1932, and/or 1934 based on the test results.

A method of three-dimensional additive manufacturing of optical devices is disclosed, that includes fabricating and measuring a test coupon as part of the manufacturing flow. In an example, the optical device is a gradient dielectric property device whereby permittivity or permeability is graded. In an example, the optical device is a gradient index (GRIN) device. In an example, the manufacturing method is additive manufacturing, including inket-printed, multi-jet fusion printed, drop-on-demand printed, and/or fused-filament fabrication (FFF) fabricated. In an example, test coupon content varies in three-dimensions. As an example, the test coupon is optimized for the visible, infrared, terahertz, radio-frequency (RF), or millimeter wavelength spectral region. In an example, the test coupon includes spatial frequency varying patterns that include contrast levels larger in number than the number of primary materials, wherein the varying pattern is a square, sinusoid, parabolic, linear, or triangular wave patterns that that may extend various lengths in the x, y, or z-dimension, and wherein the varying pattern extends various lengths in the x, y, or z-dimension. In an example, the test coupon includes bars or cubes of varying levels of index contrast that extend at one or more lengths in the x, y, or z-dimension. In an example, the test coupon includes single voxel, single voxel lines, and single voxel wide planes oriented within three-dimensions. In an example, the test coupon includes positive or negative power radial symmetry lenses, wherein the lenses varying in diameter, wherein the lenses include round, square, or hexagonal apertures wherein the lens is subtended or circumscribed, and wherein the lens includes index variation that varies radially and axially. In an example, the test coupon is fabricated using nanocomposite feedstock. In an example, the test coupon is fabricated using more than one halftoning or binarization methods. In an example, the measured data includes the optical path length (OPL) or optical path difference (OPD). In an example, an interferometer is used to measure the test coupon. In an example, a digital holographic microscope is used to measure the test coupon. In an example, Zernike decomposition of the measured data is used to optimize the device print maps. In an example, modulation transfer function data is used to optimize the device print maps. In an example, the dispersion of the optical materials is measured. In an example, the test coupon is used for process monitoring and control. In an example, the test coupon is used for real-time process monitoring and control, whereby the process parameters are changed for manufacturing the remainder of the device, and wherein the print maps are changed for manufacturing the remainder of the device. In an example, the test coupon is used to estimate the inter-diffusion of the feedstocks materials used to fabricate the device. In an example, the test coupon is used to analyze offsets in the print mechanism or printhead nozzles. In an example, the optical device is being optimized for an imaging lens, a telescope, optical scope, an antenna, a beam steering device, a microscope, a head-up display, or a display. In an example, the data from the test coupon is used to create process models used for device design for manufacturing. In an example, the data from the test coupon is used to create printer models that allow devices to be optimized for individual printers. In an example, the test coupon content is determined based on the device properties including frequency content and/or polynomial composition.

The following U.S. Patent applications are incorporated by reference herein in their entirety for all purposes: U.S. patent application Ser. No. 14/973,340, and U.S. patent application Ser. No. 14/599,731.

It will be understood that the configurations and/or approaches described herein are exemplary in nature, and that these specific examples are not to be considered in a limiting sense, because numerous variations are possible. The specific routines or methods described herein may represent one or more of any number of processing strategies. As such, various acts illustrated and/or described may be conducted in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A method of manufacturing one or more instances of a target electromagnetic device having a gradient in a dielectric property in one or more spatial dimensions of the target electromagnetic device, the method comprising:
forming a test coupon by print-based additive manufacturing according to an initial print map that defines an array of values corresponding to an array of voxels of the test coupon, wherein each value of the array of values of the initial print map defines a quantity or relative proportion of two or more component materials that differ in the dielectric property, the test coupon comprising an electromagnetic device having a test gradient in the dielectric property in one or more spatial dimensions of the test coupon,
wherein forming the test coupon comprises material deposition of the two or more component materials at relative proportions that vary in the one or more spatial dimensions of the test coupon;
testing the test coupon by measuring an electromagnetic response of the test coupon to electromagnetic radiation incident on the test coupon;
generating a target print map for the target electromagnetic device based on the measured electromagnetic response of the test coupon, the target print map defining an array of values corresponding to an array of voxels of the target electromagnetic device, wherein each value of the array of values of the target print map defines a quantity or relative proportion of the two or more component materials; and
forming the one or more instances of the target electromagnetic device by print-based additive manufacturing according to the target print map,
wherein forming the one or more instances of the target electromagnetic device by print-based additive manufacturing includes material deposition of the two or more component materials voxel-by-voxel according to the array of values of the target print map to obtain the gradient in the dielectric property of the target electromagnetic device by, for each instance of the one or more instances:
varying relative proportions of the two or more component materials in the one or more spatial dimensions of the target electromagnetic device based on the electromagnetic response measured for the test coupon.
